(19) United States
(12) Patent Application Publication
(10) Pub. No.: US 2026/0339651 A1
(43) Pub. Date: Oct. 29, 2026

(54) SYSTEM, A CLOUD PLATFORM AND A METHOD FOR IMPLEMENTING LANDING ZONES

(71) Applicant: Trianz Digital Consulting Private Limited, Bangalore South (IN)

(72) Inventors: Anil Kumar Gupta, Bangalore South (IN); Kalpana Mandloi, Bangalore South (IN); Mathanraj K A, Bangalore South (IN); Siddharth Kaul, Bangalore South (IN); Musunuri Balaram Prasad, Bangalore South (IN)

(73) Assignee: Trianz Digital Consulting Private Limited, Bangalore South (IN)

(21) Appl. No.: 19/708,960

(22) Filed: Jun. 16, 2026

(30) Foreign Application Priority Data
Jun. 25, 2025 (IN) 202541060604

(51) Int. Cl. G06F 8/65

(52) U.S. Cl. CPC G06F 8/65

(57) ABSTRACT

Described herein are a system (200), a cloud platform (400), and a method (800) for implementing a Landing Zone (500) in an IT infrastructure (600) to enable structured, policy-compliant deployment of computing operations. A modular User Response Interface (URI) (220) with five stage-specific modules (230a to 230e) facilitates granular configuration input aligned with foundation, identity, access management, network, and security domains. A Response Validation Interface (RVI) (240) enables approval workflows, dynamic question adaptation (246), and iterative updates (224). A deployment orchestrator (260) automates sequential deployment using infrastructure-as-code tools, ensuring consistency and compliance. The system supports real-time updates, multilingual interfaces, and centralized control via a unified console (250). The system supports real-time updates and centralized control via a unified console (250).

### CROSS REFERENCE TO RELATED APPLICATIONS

Benefit is claimed to Indian Patent Application No. 202541060604 filed on Jun. 25, 2025, the contents of which are incorporated by reference in their entirety.

### FIELD OF THE INVENTION

The present invention relates to landing zones in IT or cloud infrastructure for deploying computing operations. Specifically, the invention focuses on implementing landing zones in IT infrastructure. The invention provides a system, a cloud platform, and a method for implementation of landing zones for cloud computing operations.

### BACKGROUND FOR THE INVENTION

A landing zone in IT infrastructure is a predefined environment in the cloud designed to host and manage resources securely and efficiently. It includes components such as identity and access management, network topology, security measures, governance policies, and automation tools. These elements ensure that the environment is scalable, compliant, and operationally effective, providing a solid foundation for deploying and managing applications.

Landing zones are used in various cloud platforms, such as Azure, AWS, and Google Cloud (trade names), to streamline the setup and scaling of cloud environments. They are configured to support different workloads and applications, offering a structured approach to resource management and deployment. This makes them ideal for organizations looking to migrate, modernize, or innovate their IT infrastructure.

A landing zone in non-cloud IT infrastructure is a structured environment designed to host and manage computing resources efficiently and securely. It includes components such as network configuration, security protocols, identity and access management, and governance policies. These elements ensure that the environment is scalable, compliant, and operationally effective, providing a solid foundation for deploying and managing applications.

Landing zones in non-cloud IT infrastructure are used to streamline the setup and scaling of physical and virtual environments. They are configured to support different workloads and applications, offering a structured approach to resource management and deployment. This makes them ideal for organizations looking to optimize, modernize, or innovate their IT infrastructure at scale.

Implementing a landing zone in IT infrastructure for a cloud environment requires inputs and approvals from various sub-departments, such as approval authorities, IT operators, server managers, and other sub-functionalities. Currently, the landing zone architect (enablers), who designs the landing zone for a cloud computing environment (CCE), manually gathers these inputs from all departments and sub-functional departments of CCE users.

Coordinating with these stakeholders to implement the landing zone for a CCE is a tedious process. Miscommunication and organizational errors can lead to a lack of collaboration among stakeholders, affecting the efficiency of landing zone operations.

WO2024215321A1 describes a method of integrating multiple software programs for landing zone implementation. The method aims to improve collaboration between various stakeholders in implementing the Landing zone. The method does not provide mechanisms for gathering user-specific requirements, validating them, or orchestrating deployment based on approval.

US2021174280A1 describes systems and methods for efficient cloud migration. The system includes focused questionnaires and discovery routines to evaluate migration readiness. These questionnaires determine the feasibility and desirability of migrating to private or public cloud systems for applications, portfolios, or enterprises. Some questions are answered through auto-discovery and assessment routines in the MPA suite, leveraging historical data from previous migration projects. This process ensures a thorough understanding of technical and financial requirements, facilitating successful cloud migration. However, this method lacks the specific configurations needed for setting up a landing zone, which requires detailed network, security, and compliance settings. Additionally, this method does not support dynamic adjustments based on real-time usage or orchestrating deployment based on approval, which are essential for landing zone implementation.

US2020314169A1 describes a method and system for generating strategy and roadmap for end-to-end IT infrastructure cloud implementation. The method involves receiving natural language inputs from various sources to understand requirements for IT infrastructure cloud implementation. Inputs include business, technology, data, and application-related questions regarding current and future systems. Stakeholders such as business and IT personnel, end users, provide these inputs. An AI-based conversational agent interactively gathers and processes these questions, ensuring comprehensive planning and compliance with requirements. While effective for understanding IT infrastructure needs and planning, this method lacks the specific technical configurations required for setting up a landing zone, which involves detailed network, security, and compliance settings, and dynamic adjustments. Additionally, this method does not support dynamic adjustments based on real-time usage or orchestrating deployment based on approval, which are essential for landing zone implementation.

US10872029B1 describes a system, apparatus, and method for deploying infrastructure to the cloud. The system includes a user interface for cloud migration planning, featuring an App Code ID, main menu, scoring grid, and planning-information categories with associated questions. These questions, processed by the survey module, help generate scores for migration planning. The survey includes various questions on operational complexity and application size, organized by categories like Application Complexity and Business Value. Responses can be numerical, ranked, or text based. An initial cloud readiness checklist evaluates software readiness, leading to detailed survey data collection if ready. Users can adjust question weightings to customize migration plans, ensuring comprehensive and tailored cloud migration strategies. However, this survey-based method lacks the technical depth and dynamic configuration capabilities required for implementing a landing zone, which involves setting up foundational infrastructure like network, security, and compliance settings. Additionally, this method does not support dynamic adjustments based on real-time usage or orchestrating deployment based on approval, which are essential for landing zone implementation.

CN119668762A describes a task processing method, device, equipment, system, medium, and product. The method and system package ARM cloud machine foundations and provide APIs for services like real-time screenshot flow storage. It discusses large language models (LLMs) with billions of parameters, trained on extensive text data for natural language processing tasks. The system utilizes knowledge graphs for accurate and comprehensive knowledge services, emotion analysis, and intent understanding. It supports multiple rounds of conversations and context understanding, enhancing answer consistency. The user interface includes a question-answer front end and a task execution front end, enabling users to interact with the agent service for tasks like commodity approval.

The system integrates external knowledge and dynamically updates answers to maintain accuracy and relevance. However, this method focuses on task processing using LLMs for natural language processing tasks, knowledge integration, and dynamic updates, lacking the specific technical configurations required for setting up a landing zone, which involves detailed network, security, and compliance settings. Additionally, this method does not support dynamic adjustments based on real-time usage or orchestrating deployment based on approval, which are essential for landing zone implementation.

Therefore, there is a need for a system or method for implementing the landing zones in IT infrastructures (can be on-prem or cloud) which overcomes the problems of prior art.

### SUMMARY OF THE INVENTION

The present invention provides a system, a cloud platform, and a method for implementing landing zones in an IT infrastructure, addressing the need for structured configuration collection and approval-based deployment. A key object of the invention is to enable detailed configuration of landing zones, including network, security, and compliance settings, through a modular User Response Interface (URI). This interface is divided into five modules, each corresponding to a specific stage of landing zone implementation, foundation, identity, access management, network, and security. Each module presents preconfigured questions derived from a landing zone template, allowing users to input precise configuration data. These inputs are stored and processed for validation, ensuring that the landing zone setup aligns with organizational policies and technical requirements.

The present invention streamlines the validation and deployment process by integrating a Response Validation Interface (RVI) and a Deployment Orchestrator. The RVI enables an approval authority to review user responses and either approve or reject the proposed configuration. The URI includes an updating portal for revising answers and a question modifier that dynamically adjusts questions based on configuration changes. Upon approval, the Deployment Orchestrator automates the deployment of the landing zone, beginning with foundational configurations. This orchestrator supports both manual and automatic triggers and integrates with infrastructure-as-code tools to ensure consistent, policy-compliant deployment across on-prem, cloud, hybrid, and SaaS environments.

The invention offers a technical advantage by reducing manual intervention and improving collaboration among stakeholders. The modular architecture of the URI and RVI allows for distributed input and validation, while the orchestrator ensures that deployments are executed in a controlled and repeatable manner. The system supports real-time updates, multilingual interfaces, and integration with cloud-native services. The inclusion of a unified console further enhances usability by centralizing all components into a single interface.

Another technical advantage is the system’s scalability and flexibility. The invention supports deployment as a cloud-native or SaaS-based platform, enabling remote access, multi-tenant validation, and seamless integration with third-party systems. The architecture is designed to operate in distributed environments, leveraging microservices and containerized components for high availability and fault tolerance. This ensures that the system can be deployed across various IT infrastructures while maintaining performance, compliance, and operational efficiency.

### BRIEF DESCRIPTION OF DRAWINGS

FIG. 1 shows a block diagram of a system for implementing a Landing Zone in an IT (information technology) infrastructure in accordance with the present invention;

FIG. 2 and FIG. 3 are detailed block diagrams of components of the system shown in the FIG. 1;

FIGS. 4, 5 and 6 show block diagrams of alternative embodiments of the system in accordance with the present invention;

FIG. 7 shows a block diagram of a cloud platform for implementing a Landing Zone (in an IT infrastructure in accordance with the present invention; and

FIG. 8 shows a flow chart of a method for implementing a Landing Zone in an IT infrastructure in accordance with the present invention.

### DETAILED DESCRIPTION

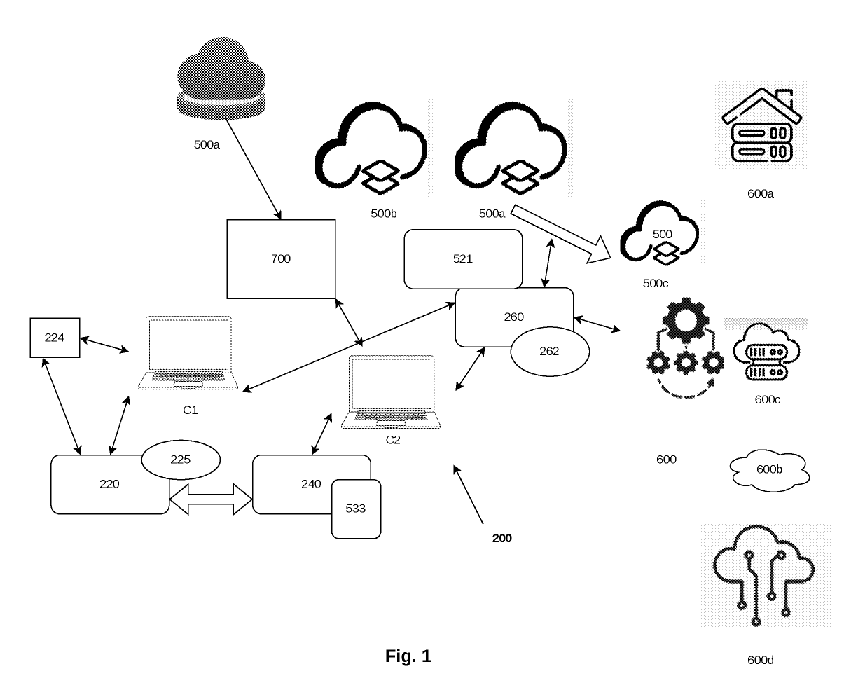

In a preferred embodiment (FIG. 1), the present invention provides a system (200) for implementing a Landing Zone (500) in an IT (information technology) infrastructure (600) for deploying and managing computing operations. The Information Technology (IT) infrastructure (600) includes physical hardware such as servers, computers, data centers, networking equipment (like routers and switches), and storage devices. The hardware and software systems include operating systems, enterprise applications, virtualization platforms, and database management tools. The IT infrastructure may include cloud services (IaaS, PaaS, SaaS), data storage solutions, backup and disaster recovery systems, and IT support services.

Deploying and managing computing operations refers to setting up and maintaining the systems that run an organization’s digital services. The deployment involves installing hardware and software, configuring networks, and launching applications or cloud services. Once deployed, the systems are monitored, updated, and secured to ensure they perform efficiently and reliably. The IT infrastructure (600) is an on-prem IT infrastructure (600a) or cloud infrastructure (600b) or hybrid infrastructure (600c) or SaaS infrastructure (600d).

The system (200) includes a User Response Interface (URI) (220), a Response Validation Interface (RVI) (240) and a deployment orchestrator (260). The URI (220) is associated with a first computing device (C1) of the IT infrastructure (600). The computing device (C1) includes a processor (not shown) and a memory (m1). The URI (220) is a module with predefines set instructions (programmed). The URI (220) is stored in the memory (m1). The URI (220) can be an application in the first computing device (C1). The URI (220) has an interface trigger (225) for triggering the functioning of the URI (220).

The processor of the first computing device (C1) executes the instructions of the User Response Interface (URI) (220) stored in the memory (m1). In one embodiment, the processor comprises a multi-core processor capable of parallel processing operations. In another embodiment, the processor comprises an Intel Core i7 processor (Trade name). In yet another embodiment, the processor comprises an AMD Ryzen processor (Trade name). The processor communicates with the memory (m1) through a system bus. The memory (m1) stores the URI (220), the library, and an answers (a1, a2) provided by a user (U1). In one embodiment, the memory (m1) comprises a volatile memory such as RAM. In another embodiment, the memory (m1) comprises DDR4 RAM (Trade name). In yet another embodiment, the memory (m1) comprises a non-volatile memory such as solid-state storage for persistent storage of the questions (q1, q2) and the answers (a1, a2).

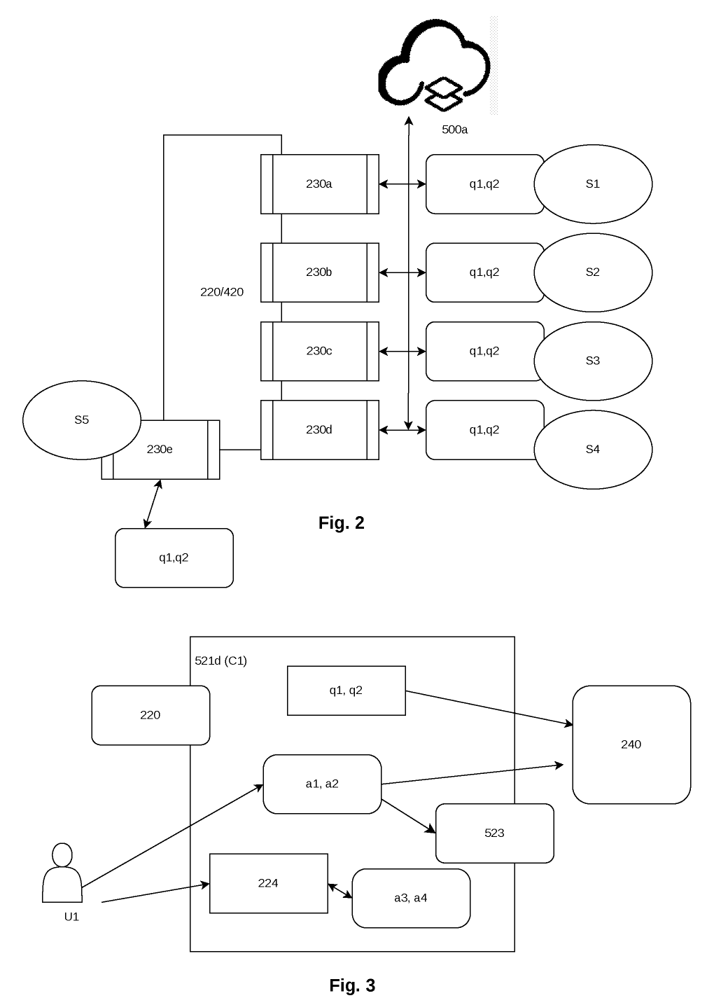

The User Response Interface (URI) (220) (FIG. 2) includes five modules (230a, 230b, 230c, 230d, 230e). Each module has a library (not shown). The library is associated with the memory (m1). Each module (230a/ 230b/ 230c/ 230d/ 230e) has one or more questions (q1, q2)). The questions (q1, q2) are prestored in the library. The questions (q1, q2) are related to the landing zone (500) that needs to be implemented in the IT infrastructure (600) and are derived from a preconfigured landing zone (500a). The questions (q1, q2) can be updated in real time or by a machine learning module (not shown). Example of the such questions include “enter the policy template”, “what is the policy number”, “would you like to start identity configuration with recommended proposal?” or any such format of sentences which is intended to receive an input from a user which are relevant to the landing zone implementation.

The preconfigured landing zone (500a) is a pre-defined template or baseline configuration containing questions (q1, q2) organized by configuration stage, recommended security policies specific to the IT infrastructure type, default network topology parameters; and governance rules and compliance frameworks applicable to the target environment.

The library associated with the memory (m1) stores the questions (q1, q2) in a structured format. In one embodiment, the library comprises a relational database. In another embodiment, the library comprises a MySQL database (Trade name). In yet another embodiment, the library comprises a NoSQL database such as MongoDB (Trade name). The library organizes the questions (q1, q2) according to the five modules (230a, 230b, 230c, 230d, 230e). Each module (230a/230b/230c/230d/230e) has a dedicated section within the library. The library supports real-time updates to the questions (q1, q2) through administrative access. In one embodiment, the machine learning module analyzes historical answers (a1, a2) and updates the questions (q1, q2) based on based on recurring configuration patterns identified in historical user responses, enabling dynamic refinement of subsequent questions. In another embodiment, the machine learning module comprises a natural language processing engine. The machine learning module communicates with the library to modify the questions (q1, q2) dynamically based on user interaction patterns and deployment outcomes.

The first module (230a) of the five modules includes questions (q1, q2) related to a foundation stage (S1) of the landing zone implementation. The second module (230b) includes questions related to an identity stage (S2) of the landing zone implementation. The third module (230c) includes questions related to an access management stage (S3) of the landing zone implementation. The fourth module (230d) includes questions related to a network configuration stage (S4) of the landing zone implementation. The fifth module (230e) includes questions related to Security stage (S5) of landing zone implementation.

The first module (230a) presents questions (q1, q2) related to the foundation stage (S1) of the landing zone (500) implementation. The questions (q1, q2) in the first module (230a) gather information about organizational structure, account setup, and baseline policies. In one embodiment, the questions (q1, q2) in the first module (230a) include queries about management account configuration. In another embodiment, the questions (q1, q2) include queries about billing and cost management preferences. In yet another embodiment, the questions (q1, q2) include queries about logging and monitoring requirements. The first module (230a) stores the answers (a1, a2) related to the foundation stage (S1) in the memory (m1). The first module (230a) validates the format of the answers (a1, a2) before storing them in a memory (523). In one embodiment, the validation comprises checking for alphanumeric format compliance. In another embodiment, the validation comprises checking for JSON schema compliance for structured configuration data.

The second module (230b) presents questions (q1, q2) related to the identity stage (S2) of the landing zone (500) implementation. The questions (q1, q2) in the second module (230b) gather information about user authentication, identity providers, and directory services. In one embodiment, the questions (q1, q2) in the second module (230b) include queries about single sign-on configuration. In another embodiment, the questions (q1, q2) include queries about multi-factor authentication requirements. In yet another embodiment, the questions (q1, q2) include queries about integration with existing identity management systems such as Active Directory (Trade name). The second module (230b) stores the answers (a1, a2) related to the identity stage (S2) in the memory (m1). The answers (a1, a2) provided through the second module (230b) define the identity and access management framework for the landing zone (500).

The third module (230c) presents questions (q1, q2) related to the access management stage (S3) of the landing zone (500) implementation. The questions (q1, q2) in the third module (230c) gather information about role-based access controls, permission policies, and privilege escalation procedures. In one embodiment, the questions (q1, q2) in the third module (230c) include queries about administrative access levels. In another embodiment, the questions (q1, q2) include queries about least privilege enforcement policies. In yet another embodiment, the questions (q1, q2) include queries about service account management. The third module (230c) stores the answers (a1, a2) related to the access management stage (S3) in the memory (m1). The answers (a1, a2) determine the access control matrix for the landing zone (500).

The fourth module (230d) presents questions (q1, q2) related to the network configuration stage (S4) of the landing zone (500) implementation. The questions (q1, q2) in the fourth module (230d) gather information about network topology, IP addressing schemes, subnet configurations, and connectivity requirements. In one embodiment, the questions (q1, q2) in the fourth module (230d) include queries about virtual private cloud configuration. In another embodiment, the questions (q1, q2) include queries about DNS configuration and domain name management. In yet another embodiment, the questions (q1, q2) include queries about hybrid connectivity requirements such as VPN or dedicated connections. The fourth module (230d) stores the answers (a1, a2) related to the network configuration stage (S4) in the memory (m1). The answers (a1, a2) define the network architecture for the landing zone (500).

The fifth module (230e) presents questions (q1, q2) related to the security stage (S5) of the landing zone (500) implementation. The questions (q1, q2) in the fifth module (230e) gather information about encryption standards, security monitoring, threat detection, and compliance requirements. In one embodiment, the questions (q1, q2) in the fifth module (230e) include queries about data encryption at rest and in transit. In another embodiment, the questions (q1, q2) include queries about security information and event management integration. In yet another embodiment, the questions (q1, q2) include queries about compliance frameworks such as ISO 27001 or SOC 2 (Trade name). The fifth module (230e) stores the answers (a1, a2) related to the security stage (S5) in the memory (m1). The answers (a1, a2) establish the security posture for the landing zone (500).

When the user (U1) wants to implement the landing zone (500) in the infrastructure (600) by the system (200), the user (U1) needs to activate the functioning of the URI (220). The URI (220) displays the questions (q1, q2) on a display (521d) of the computing device (C1). The questions can be configured in the library in multiple languages. The computing device (C1) may use any obvious translating modules to change language of the questions (q1, q2).

The display (521d) of the computing device (C1) renders the questions (q1, q2) in a graphical user interface. In one embodiment, the display (521d) comprises an LCD display. In another embodiment, the display (521d) comprises an LED display. In yet another embodiment, the display (521d) comprises an OLED display (Trade name). The graphical user interface presents the questions (q1, q2) in a sequential manner according to the module order. The interface trigger (225) activates the User Response Interface (URI) (220) (U1) initiates the landing zone (500) implementation process. In one embodiment, the interface trigger (225) comprises a clickable button on the display (521d). In another embodiment, the interface trigger (225) comprises a voice command interface. The translating modules convert the questions (q1, q2) from a default language to the preferred language of the user (U1). In one embodiment, the translating module comprises a real-time translation engine. In another embodiment, the translating module comprises Google Translate API (Trade name).

The questions (q1, q2) are displayed on the display (521d) in the user’s (U1) preferred language. The user (U1) needs to answer these questions (q1, q2) based on a requirement of the landing zone or any such relevant details which are parametrically significant in implementation of the landing zone (500). The user (U1) can be one person or a team who are stakeholders in implementing the landing zone. The user (U1) can be a user of the IT infrastructure (600). The user (U1) can be a part of the user’s team. The user (U1) can answer these questions by typing the answers (a1, a2) through a keyboard (not shown) of the computing device (C1) or by giving vocal inputs through a microphone (not shown) or any such obvious user interfaces. These answers (a1, a2) are stored in the memory (523).

The memory (523) stores the answers (a1,a2) in a structured data format. In one embodiment, the memory (523) comprises a portion of the memory (m1) allocated specifically for answer storage. In another embodiment, the memory (523) comprises a separate physical storage device. In yet another embodiment, the memory (523) comprises cloud-based storage accessible through an API. The memory (523) organizes the answers (a1, a2) according to the corresponding questions (q1, q2) and the modules (230a, 230b, 230c, 230d, 230e). Each answer (a1/a2) is tagged with metadata including a timestamp, a user identifier, and a module identifier. The memory (523) supports concurrent read and write operations. In one embodiment, the memory (523) implements a locking mechanism to prevent data corruption during simultaneous access. The memory (523) maintains version history of the answers (a1, a2) to enable rollback to previous configurations if required.

The Response Validation Interface (RVI) (240) implements authentication mechanisms to control access by an approval authority (700). In one embodiment, the authentication comprises username and password verification. In another embodiment, the authentication comprises multi-factor authentication requiring a time-based one-time password. In yet another embodiment, the authentication comprises biometric authentication such as fingerprint or facial recognition. The RVI (240) grants access to the approval authority (700) only after successful authentication. The RVI (240) maintains an access log recording for each login attempt by the approval authority (700). In one embodiment, the access log comprises timestamps and IP addresses. The RVI (240) enforces session timeout policies to terminate inactive sessions. In one embodiment, the session timeout is configured to be 30 minutes. In another embodiment, the session timeout is configurable by an administrator.

A second computing device (C2) comprises a processor that executes the Response Validation Interface (RVI) (240) and a memory (533) that stores the RVI (240). In one embodiment, the processor of the second computing device (C2) comprises a server-grade processor. In another embodiment, the processor comprises an Intel Xeon processor (Trade name). In yet another embodiment, the processor comprises an AMD EPYC processor (Trade name). The memory (533) stores the gathered details of the answers (a1, a2) and the questions (q1, q2) received from the first computing device (C1). In one embodiment, the memory (533) comprises a high-capacity RAM for handling multiple validation sessions. In another embodiment, the memory (533) comprises ECC RAM (Trade name) for error correction. The second computing device (C2) is communicatively connected to the first computing device (C1) through a network connection. In one embodiment, the network connection comprises a local area network. In another embodiment, the network connection comprises a wide area network. In yet another embodiment, the network connection comprises a secure VPN connection for encrypted data transmission.

The (RVI) (240) is associated with the second computing device (C2). The second computing device (C2) has a processor and a memory (533). The RVI (240) is a set of programmes configured in the memory (533). The computing device (C2) is functionally connected with the first computing device (C1). The first computing device (C1) and the second computing device (C2) can be the same. The RVI (240) is connected to the URI (220) for gathering details of the answers (a1, a2) and the questions (q1, q2) thereto. The RVI (240) functioning continues. The RVI (240) is accessible to the approval authority (700) through specific authenticating access methods.

The approval authority (700) is a person or a team or part of a team. The approval authority (700) is stakeholder in implementing the landing zone (500) in the IT infrastructure (600). The gathered details of the answers (a1, a2) and the questions (q1, q2) are displayed on a display (not shown) or any such user interface(s) of the second computing device (C2). The details gathered are conveyed to the approval authority (700). The approval authority (700) approves or rejects an implementation of the preconfigured landing zone (500a) in the IT infrastructure (600) based on the answers (a1, a2) by the user to the questions (q1, q2).

Icons for “approving” and “rejecting” the implementation of the landing zone are displayed on the display of the second computing device (C2). It may be obvious to a person skilled in the art to configure the RVI (240) which displays icons of the approving and the rejecting in the display. In Another embodiment, the operations of the approval and rejection can be performed verbally through user interfaces of the second computing device (C2).

The approval authority (700) reviews the gathered details of the answers (a1, a2) and the questions (q1, q2) displayed on the display of the second computing device (C2). The approval authority (700) evaluates whether the answers (a1, a2) satisfy the requirements for implementing the preconfigured landing zone (500a). The Response Validation Interface (RVI) (240) presents the answers (a1, a2) in a structured format organized by the five modules (230a, 230b, 230c, 230d, 230e). In one embodiment, the RVI (240) displays the answers (a1, a2) in a tabular format. In another embodiment, the RVI (240) displays the answers (a1, a2) in a tree structure showing hierarchical relationships. The approval authority (700) clicks an approve icon to approve the implementation of the preconfigured landing zone (500a). In one embodiment, the approve icon comprises a green checkmark button. Upon approval, the RVI (240) generates an approval record containing a timestamp, an identifier of the approval authority (700), and a reference to an approved landing zone (500b). The approval record is stored in the memory (533) of the second computing device (C2).

The approval authority (700) clicks a reject icon to reject the implementation of the preconfigured landing zone (500a) if the answers (a1, a2) do not satisfy the requirements. In one embodiment, the reject icon comprises a red cross button. Upon rejection, the RVI (240) prompts the approval authority (700) to provide rejection comments explaining the reasons for rejection. The rejection comments are stored in the memory (533) and are transmitted to the User Response Interface (URI) (220). The URI (220) displays the rejection comments to the user (U1) on the display (521d) of the first computing device (C1). The user (U1) accesses an updating portal (224) to modify the answers (a1, a2) based on the rejection comments. In one embodiment, the updating portal (224) highlights the specific questions (q1, q2) that require updated answers. The user (U1) submits the updated answers (a3, a4) through the updating portal (224). The updated answers (a3, a4) are stored in the memory (523) replacing the previous answers (a1, a2).

Implementing the landing zone (500) in the IT infrastructure involves a comprehensive setup of both software configurations and supporting hardware elements to establish a secure, scalable, and compliant environment for deploying workloads typically in a cloud or hybrid environment. At the software level, this begins with configuring identity and access management (IAM) systems to enforce role-based access controls and integrate with centralized identity providers. Simultaneously, networking components such as virtual networks, subnets, firewalls, and routing tables are defined and deployed to ensure secure and segmented communication across systems. Security configurations are applied through automated policies, encryption standards, and logging mechanisms to ensure compliance and traceability.

On the infrastructure side, the landing zone leverages virtualized compute, storage, and networking resources, often provisioned through Infrastructure as Code (IaC) tools like Terraform or CloudFormation. These tools automate the deployment of consistent environments across multiple accounts or subscriptions. Hardware considerations include ensuring that the underlying physical servers, storage arrays, and network switches in data centers or cloud regions can support the desired performance, redundancy, and scalability. Monitoring and logging systems are configured to collect telemetry data from both software and hardware layers, feeding into centralized dashboards and alerting systems. Further, cost management tools are integrated to track resource usage and optimize spending, ensuring that both software and hardware resources are used efficiently within the landing zone framework.

The preconfigured landing zone (500a) has a set of hardware and software according to the required implementation with components mentioned. The preconfigured landing zone (500a) can be an application or a module which is stored in the memory (m1). Both the first computing device (C1) and the second computing device (C2) has access to the memory (m1). A developer configures the landing zone. The developer can be a software architect or a vendor or an implementor and one of the stakeholders in the landing zone implementation process.

The deployment orchestrator (260) is associated with the first computing device (C1), the second computing device (C2) and the IT infrastructure (600). The deployment orchestrator (260) deploys an approved landing zone (500b) in the IT infrastructure (600). Deploying here refers to execution of implementation of the landing zone (500) in the IT infrastructure (600). The deployment orchestrator (260) is an application module. Specifically, the deployment orchestrator (260) is an execution application and has a set of applications for implementing the landing zone.

The deployment orchestrator (260) is activated automatically after the approval authority (700) approves the installation. In Another embodiment, the deployment orchestrator (260) is activated using a deployment trigger (262) which can be an additional application.

The deployment orchestrator (260) comprises a set of execution modules that automate the deployment of the approved landing zone (500b) in the IT infrastructure (600). In one embodiment, the deployment orchestrator (260) utilizes infrastructure-as-code tools. In another embodiment, the deployment orchestrator (260) utilizes Terraform (Trade name) for provisioning infrastructure resources. In yet another embodiment, the deployment orchestrator (260) utilizes AWS CloudFormation (Trade name) for cloud-based deployments. The deployment orchestrator (260) reads the answers (a1, a2) from the memory (523) and converts the answers (a1, a2) into deployment scripts. The deployment scripts define the configuration parameters for the landing zone (500). In one embodiment, the deployment scripts comprise JSON format configuration files. In another embodiment, the deployment scripts comprise YAML format configuration files. The deployment orchestrator (260) executes the deployment scripts sequentially according to the stage dependencies. The deployment orchestrator (260) provisions compute resources, configures networking components, and applies security policies in the IT infrastructure (600) based on the deployment scripts.

The deployment trigger (262) initiates the functioning of the deployment orchestrator (260). In one embodiment, the deployment trigger (262) comprises an API call from the Response Validation Interface (RVI) (240). In another embodiment, the deployment trigger (262) comprises a manual button click by an administrator on a deployment dashboard. The deployment trigger (262) sends a deployment initiation signal to the deployment orchestrator (260). The deployment orchestrator (260) verifies that the approved landing zone (500b) has valid approval status before commencing deployment. The deployment orchestrator (260) checks the approval record stored in the memory (533). In one embodiment, the deployment orchestrator (260) validates a digital signature associated with the approval record. Upon successful validation, the deployment orchestrator (260) proceeds with the deployment. The deployment orchestrator (260) logs each deployment step in a deployment log. In one embodiment, the deployment log comprises timestamps, status codes, and error messages. In another embodiment, the deployment log is stored in a centralized logging system such as ELK Stack (Trade name).

Further, the URI (220) includes the updating portal (224). The updating portal (224) is accessed by the user in(on) the first computing device (C1). When the approval authority (700) rejects the implementation of the landing zone, the user (U1) can update the answers to the questions (q1, q2) in the updating portal. Additionally, the questions (q1, q2) can also be updated in the library by the implementor. The configurations of the landing zone (500) can be changed based on the rejection.

The updating portal (224) provides a user interface for the user (U1) to modify the answers (a1, a2) that were rejected by the approval authority (700). The updating portal (224) retrieves the rejection comments from the Response Validation Interface (RVI) (240) and displays the rejection comments alongside the relevant questions (q1, q2). In one embodiment, the updating portal (224) highlights the questions (q1, q2) requiring modification in a distinct color. In another embodiment, the updating portal (224) presents the questions (q1, q2) in a wizard-style interface guiding the user (U1) through the update process. The user (U1) enters the updated answers (a3, a4) through input fields in the updating portal (224). The updating portal (224) validates the format and content of the updated answers (a3, a4). In one embodiment, the validation comprises checking for required fields. In another embodiment, the validation comprises checking for data type compatibility. The updating portal (224) stores the updated answers (a3, a4) in the memory (523) with a version number indicating the revision. The updating portal (224) notifies the Response Validation Interface (RVI) (240) that updated answers (a3, a4) are available for review. The approval authority (700) receives a notification on the second computing device (C2) to review the updated answers (a3, a4).

According to the updated questions, the answers (a1, a2) are changed. When the user submits these updated answers (a3, a4), the same updated answers are gathered at the RVI (240). The approval authority (700) may approve the implementation of an updated landing zone (500c) based on the updated answers (a3, a4).

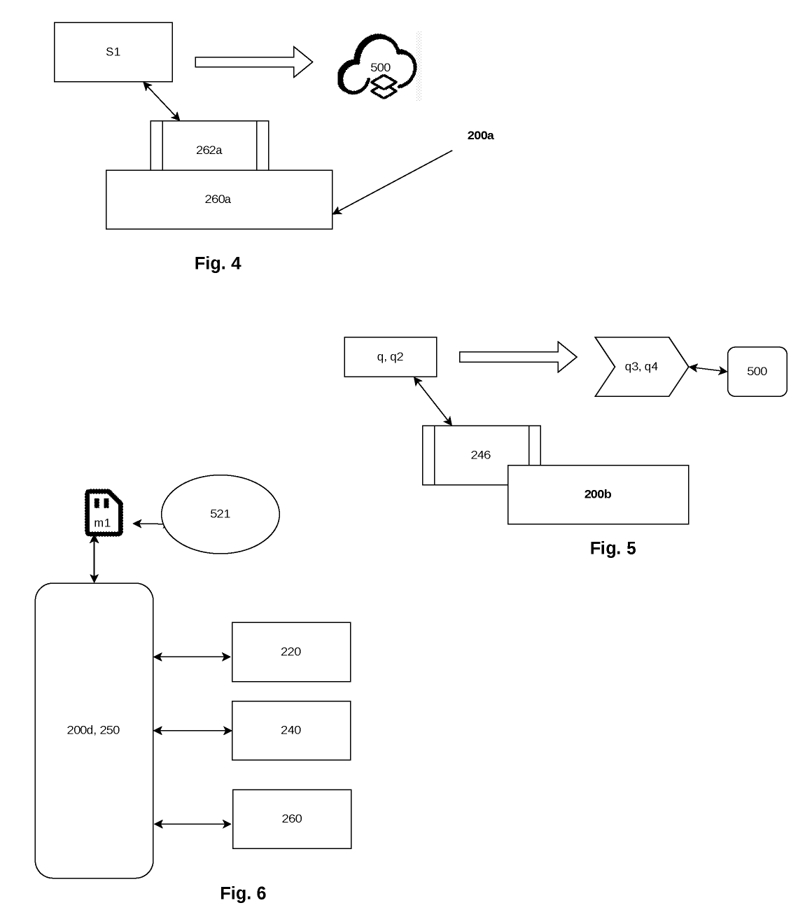

In Another embodiment (200a) (FIG. 4) of the system (200), the system (200a) includes a deployment orchestrator (260a). The functioning and configuration of the deployment orchestrator (260a) is same as the deployment orchestrator (260) of the system (200). Additionally, the deployment orchestrator (260a) is adapted to deploy the configurations related to the foundation stage (S1) firstly for the implementation of the landing zone (500). The deployment orchestrator (260a) has a directing module (262a) which enables the deployment orchestrator (260a) to perform the execution of configurations related to the foundation stage (S1) of the landing zone (500) first. The execution of configurations related to the foundation stage (S1) can be manually triggered or can be automatically performed after the approval.

The directing module (262a) within the deployment orchestrator (260a) controls the deployment sequence to ensure that the configurations related to the foundation stage (S1) are deployed first. The directing module (262a) reads the answers (a1, a2) associated with the first module (230a) from the memory (523). The directing module (262a) generates deployment scripts specifically for the foundation stage (S1) configurations. In one embodiment, the deployment scripts for the foundation stage (S1) include account setup, organizational unit structure, and baseline security policies. The directing module (262a) executes the foundation stage (S1) deployment scripts before processing the configurations for the identity stage (S2), the access management stage (S3), the network configuration stage (S4), and the security stage (S5). The directing module (262a) monitors the deployment status of the foundation stage (S1) configurations. In one embodiment, the directing module (262a) waits for successful completion of the foundation stage (S1) before proceeding to subsequent stages. In another embodiment, the directing module (262a) implements a timeout mechanism triggering an alert if the foundation stage (S1) deployment exceeds a predefined duration. The directing module (262a) logs the completion status of the foundation stage (S1) deployment in the deployment log.

In Another embodiment (200b) (FIG. 5) of the system (200), a system (200b), the Response Validation Interface (RVI) (240) has a questions modifier (246). The questions modifier (246) is configured to dynamically update or alter a predefined set of a questions (e.g., q3, q4) based on changes to the configuration of the landing zone (500). In Another embodiment, the questions modifier (246) can be a part of the User Response Interface (URI) (220) for updating the questions (q1 q2).

When the approval authority (700) evaluates and subsequently rejects the proposed implementation of the initial landing zone (500), the system (200b) allows for the configuration of the landing zone (500) to be modified in response to the rejection. Upon such modification, resulting in a revised modified landing zone configuration (500c), the questions modifier (246) automatically modifies the associated questions (q3, q4) to reflect the updated parameters, constraints, or characteristics of the modified landing zone (500c).

This ensures that the questions (q1, q2, q3) presented for validation or further review are always contextually aligned with the most current version of the landing zone configuration, thereby enhancing the relevance and accuracy of the validation process prior to resubmission for approval.

The questions modifier (246) analyzes the modified landing zone configuration (500c) to identify configuration changes compared to the preconfigured landing zone (500a). The questions modifier (246) accesses the library associated with the memory (m1) to retrieve the original questions (q1, q2). The questions modifier (246) applies a set of modification rules to generate the modified questions (q3, q4). In one embodiment, the modification rules comprise conditional logic based on configuration parameter values. In another embodiment, the modification rules comprise a rule engine that evaluates configuration dependencies. The questions modifier (246) replaces the original questions (q1, q2) with the modified questions (q3, q4) in the relevant modules (230a/230b/230c/230d/230e). In one embodiment, the questions modifier (246) updates only the questions (q1, q2) affected by the configuration changes. The questions modifier (246) stores the modified questions (q3, q4) in the library. The User Response Interface (URI) (220) displays the modified questions (q3, q4) to the user (U1) when the updating portal (224) is accessed. The user (U1) provides updated answers (a3, a4) to the modified questions (q3, q4). The questions modifier (246) maintains a change history recording the original questions (q1, q2) and the modified questions (q3, q4) for audit purposes.

In one embodiment of the present invention, a system (200d) (FIG. 6) comprises a console (250) that integrates multiple functional modules. The modules are the User Response Interface (URI) (220) for capturing user inputs, the Response Validation Interface (RVI) (240) for verifying the accuracy and compliance of those inputs, and the Deployment Orchestrator (260) for managing the execution and deployment of validated responses. Each of these components is modularly designed to ensure flexibility and scalability within the system.

The console (250) is stored in the memory unit (m1) of a computing device (C1). The memory (m1) may be volatile or non-volatile and is accessible by the system’s processor (not shown) for runtime operations. The modular architecture of the console enables efficient user interaction, real-time validation, and seamless orchestration of deployment tasks, thereby enhancing the overall performance and reliability of the system.

The console (250) provides a unified interface integrating the User Response Interface (URI) (220), the Response Validation Interface (RVI) (240), and the deployment orchestrator (260). The console (250) is accessed through a web-based application running in a web browser on the computing device (C1). In one embodiment, the web-based application comprises a single-page application built using React framework (Trade name). In another embodiment, the web-based application comprises an Angular framework (Trade name). The console (250) presents navigation controls allowing the user (U1) and the approval authority (700) to switch between the URI (220), the RVI (240), and the deployment orchestrator (260). In one embodiment, the navigation controls comprise a sidebar menu with clickable tabs.

The console (250) implements role-based access control restricting access to specific components based on user roles. In one embodiment, the user (U1) has access to the URI (220) and the updating portal (224), while the approval authority (700) has access to the RVI (240). The console (250) displays real-time status updates for ongoing deployments. In one embodiment, the console (250) includes a dashboard showing deployment progress indicators. The console (250) communicates with the memory (m1) and the memory (533) to retrieve and display data. The console (250) sends commands to the deployment orchestrator (260) through API calls.

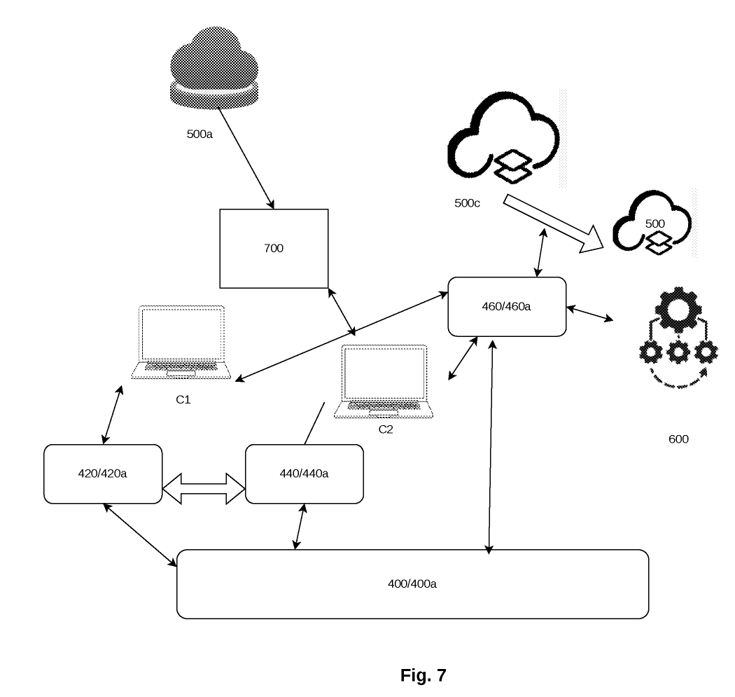

In Another embodiment of the invention (FIG. 7), a cloud platform (400) for implementing the Landing Zone (500) in the IT infrastructure (600) for deploying and managing cloud computing operations is provided. The cloud platform (400) is configured in a processor with a memory of the IT infrastructure (600). The cloud platform (400) is architected to operate in a distributed, scalable, and service-oriented manner, ensuring compatibility with cloud-native principles such as modularity, elasticity, and remote accessibility.

The cloud platform (400) includes a User Response Interface (URI) (420), a Response Validation Interface (RVI) (440) and a deployment orchestrator (460).

The User Response Interface (URI) (420) has five modules (230a, 230b, 230c, 230d, and 230e). The module (230a/ 230b/ 230c/ 230d/ 230e) of the URI (420) has one or more questions (q1, q2). The User Response Interface (URI) (420) comprises five modular components (230a to 230e), each designed to present one or more context-specific questions (q1, q2) to the user. These questions are dynamically derived from the preconfigured landing zone template (500a) and are tailored to gather configuration preferences and operational requirements for the target landing zone (500). The modular design allows the URI (420) to be deployed as micro-services or containerized components, enabling seamless integration with web-based dashboards or cloud portals.

The (RVI) (440) is connected to the URI (420) for gathering the details of the answers (a1, a2) and the questions (q1, q2), The RVI (440) is accessible to the approval authority (700) to approve or reject an implementation of the preconfigured landing zone (500a) in the IT infrastructure (600) based on the answers (a1, a2) by the user to the questions (q1, q2). The Response Validation Interface (RVI) (440) is connected to the URI and is responsible for collecting and structuring the user-provided answers (a1, a2) along with their corresponding questions. It is accessible to an approval authority (700) through secure, role-based access controls, allowing for remote validation and governance. The RVI (440) is designed to operate as a stateless service, ensuring high availability and fault tolerance in cloud environments.

The deployment orchestrator (460) is connected with the URI (420), the RVI (440) and the IT infrastructure (600). The deployment orchestrator (460) deploys the approved landing zone (500b) in the IT infrastructure (600). The Deployment Orchestrator (460) interfaces with the URI, RVI, and the underlying IT infrastructure (600) to automate the deployment of the approved landing zone (500b). The Deployment Orchestrator (460) leverages cloud orchestration tools and APIs to provision resources, configure services, and enforce compliance policies. The Deployment Orchestrator (460) supports asynchronous execution and event-driven workflows, making it suitable for hybrid and multi-cloud deployments.

The configurations, components, functions, connections of the URI (420), the RVI (440), and the deployment orchestration (460) are same as of the URI (220), the RVI (240), and the deployment orchestration (260) with additional obvious modules which enable the URI (420), the RVI (440), and the deployment orchestration (460) to work in a cloud environment.

The cloud platform (400) is deployed on cloud infrastructure (600b) comprising virtualized computing resources. In one embodiment, the cloud infrastructure (600b) comprises Amazon Web Services infrastructure (Trade name). In another embodiment, the cloud infrastructure (600b) comprises Microsoft Azure infrastructure (Trade name). In yet another embodiment, the cloud infrastructure (600b) comprises Google Cloud Platform infrastructure (Trade name). The cloud platform (400) utilizes cloud-native services for implementing the User Response Interface (URI) (420), the Response Validation Interface (RVI) (440), and the deployment orchestrator (460).

In one embodiment, the URI (420) is deployed as a containerized application using Docker containers (Trade name). In another embodiment, the URI (420) is deployed using Kubernetes orchestration (Trade name) for managing container instances. The RVI (440) is implemented as a microservice accessible through RESTful APIs. In one embodiment, the RVI (440) is deployed on serverless computing infrastructure such as AWS Lambda (Trade name). The deployment orchestrator (460) integrates with cloud service provider APIs to provision resources in the cloud infrastructure (600b). The cloud platform (400) implements auto-scaling capabilities adjusting computing resources based on workload demand. In one embodiment, the auto-scaling comprises horizontal scaling adding additional instances of the URI (420) or the RVI (440) during peak usage.

In Another embodiment (400a) of the cloud, a User Response Interface (URI) (420a), a Response Validation Interface (RVI) (440a) and a deployment orchestrator (460a) are SaaS applications.

Each component is hosted in a cloud environment and is accessible via secure web interfaces or application programming interfaces (APIs) over the internet.

The URI (420a), as a SaaS module, enables remote interaction for inputting configuration-related responses derived from a preconfigured landing zone template. The cloud-native design of the URI (420a) ensures high availability, scalability, and integration compatibility with third-party identity and access management systems.

The RVI (440a), delivered as a SaaS application, facilitates centralized validation of configuration responses. Multi-tenant access is supported, allowing authorities to review, approve, or reject configurations from distributed locations while maintaining data isolation and compliance with organizational policies.

The Deployment Orchestrator (460a), operating as a SaaS-based automation engine, coordinates deployment of approved landing zones across distributed IT infrastructures. Integration with cloud orchestration frameworks and infrastructure-as-code tools enables consistent, repeatable, and policy-compliant deployments across hybrid or multi-cloud environments.

The User Response Interface (URI) (420a) as a SaaS application is accessed by the user (U1) through a web browser without requiring local installation. The URI (420a) supports multi-tenancy allowing multiple organizations to use the URI (420a) simultaneously with data isolation. In one embodiment, the URI (420a) implements tenant-specific databases ensuring that the answers (a1, a2) from one organization are not accessible to another organization. In another embodiment, the URI (420a) implements row-level security in a shared database. The URI (420a) provides subscription-based access requiring authentication through a subscription management system. In one embodiment, the subscription management system comprises Stripe integration (Trade name).

The Response Validation Interface (RVI) (440a) as a SaaS application enables the approval authority (700) to access the RVI (440a) from any location with internet connectivity. The RVI (440a) implements secure communication protocols. In one embodiment, the secure communication comprises HTTPS encryption with TLS 1.3 protocol (Trade name). The deployment orchestrator (460a) as a SaaS application connects to the IT infrastructure (600) through secure API gateways. In one embodiment, the API gateways implement OAuth 2.0 authentication (Trade name). The deployment orchestrator (460a) provisions resources in the cloud infrastructure (600b) based on the approved landing zone (500b) without requiring manual intervention.

The system (200) comprises three memory designations(m1, 533, 523). The Memory (m1) is the primary memory of the first computing device (C1), storing the URI (220), library, and associated data structures. The Memory (523) is allocated within or external to memory (m1) specifically for storing user-provided answers (a1, a2). The Memory (533) is the memory of the second computing device (C2), storing the RVI (240), approval records, and validation data. In one embodiment, memories (523) and (533) are communicatively connected for data retrieval and synchronization.

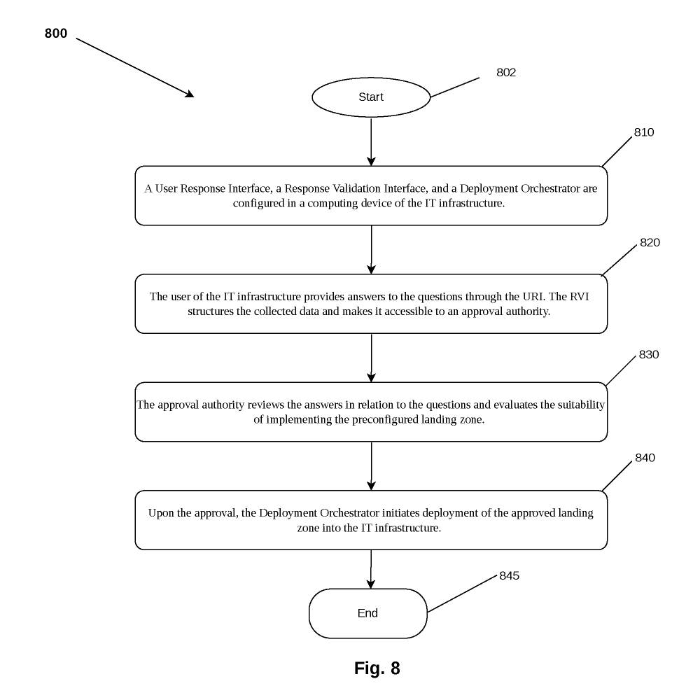

In Another embodiment of the present invention (FIG. 8), a method (800) for implementing the landing zone (500) in the IT infrastructure (600) is provided. The method (800) starts at step 802.

At step 810, the User Response Interface (URI) (220/420), the Response Validation Interface (RVI) (240/440), and the Deployment Orchestrator (260/460) are configured in the computing device (C1) of the IT infrastructure (600).

At Step 820, the user of the IT infrastructure (600) provides answers (a1, a2) to the questions (q1, q2) through the URI (220/420). The RVI (240/440) structures the collected data and makes it accessible to the approval authority (700).

At Step 830, the approval authority (700) reviews the answers (a1, a2) in relation to the questions (q1, q2) and evaluates the suitability of implementing the preconfigured landing zone (500a). Based on this evaluation, the authority (700) either approves or rejects the implementation. The decision is recorded and processed through the RVI (240/440).

At Step 840, upon the approval, the Deployment Orchestrator (260/460) initiates deployment of the approved landing zone (500b) into the IT infrastructure (600). The orchestrator (260/460) provisions resource and applies configurations based on the validated inputs. This step ensures automated deployment of the landing zone (500b). The method ends at step 845.

If a user requires to implement the Landing zone (500) in the IT infrastructure (600), the user (U1) can use the system (200).

If the user (U1) requires executing configuration of the foundation module while implementing the landing zone (500), the user can use the system (200a)

If the user (U1) requires modifying the questions according to modification of the landing zone (500) automatically, the user (U1) can use the system (200b).

If the user (U1) requires the console (250) for implementing the landing zone (500), the user (U1) can use the system (200d).

If the user (U1) requires a platform under a cloud environment for implementing the landing zone (500), the user (U1) can use the cloud platform (400).

If the user (U1) requires implementation of the landing zone (500) in a SaaS environment, the user (U1) can use the cloud platform (400a).

The user (U1) can follow the steps of the method (800) for implementing the landing zone (500) in the IT infrastructure (600).

The present invention has an advantage of enabling structured and stage-wise configuration collection through the User Response Interface (URI) (220) having the five modules (230a–230e), each aligned with a specific stage of landing zone implementation—foundation, identity, access management, network, and security. This modular design ensures that user inputs are comprehensive and tailored to the specific needs of each configuration domain, thereby supporting detailed and accurate deployment planning.

One more advantage of the present invention is the streamlined validation and approval process facilitated by the Response Validation Interface (RVI) (240), which allows the approval authority (700) to assess user responses (a1, a2) and either approve or reject the proposed landing zone. The inclusion of the updating portal (224) and the questions modifier (246) further enhances said process by enabling iterative refinement and dynamic adaptation of questions based on configuration changes, ensuring compliance and reducing errors.

One more advantage of the present invention is the automated and sequential deployment of approved configurations using the deployment orchestrator (260), which connects URI (220), RVI (240), and the IT infrastructure (600) to execute deployment beginning with foundational elements. Said automation reduces manual intervention, accelerates implementation, and ensures consistency across environments.

One more advantage of the present invention is flexibility and scalability thereof across infrastructure types, including on-prem (600a), cloud (600b), hybrid (600c), and SaaS (600d) environments. The system’s ability to operate through the unified console (250) or as the cloud/SaaS platform enhances collaboration among stakeholders and supports diverse deployment scenarios, thereby reducing implementation time and improving operational efficiency.

### Disclaimer

All third-party trademarks, service marks, trade names, or product names appearing in this specification are the property of their respective owners. They are used solely for identification, descriptive, or illustrative purposes to demonstrate interoperability or compatibility with the systems, platforms, or services referenced herein. Such use does not imply any affiliation, endorsement, or relationship between the applicant and the respective trademark owners. All rights in the referenced trademarks are hereby acknowledged.

All copyrighted materials, technical specifications, software code, and intellectual property referenced herein remain the property of their respective copyright holders. Such materials are referenced solely for technical illustration or comparative analysis without implying any license grant, authorization, or relationship between the applicant and respective owners. No copyrighted content has been reproduced or incorporated into this specification.

1. A system (200) for implementing a Landing Zone (500) in an IT infrastructure (600), wherein the landing zone (500) is configured for deploying and managing computing operations for deploying and managing computing operations, the system (200) comprising:
a User Response Interface (URI) (220) associated with a first computing device (C1) of the IT infrastructure (600), the User Response Interface (URI) (220) comprises five modules (230a, 230b, 230c, 230d, 230e), each module (230a/ 230b/ 230c/ 230d/230e) is having one or more questions (q1, q2), the questions (q1, q2) are related to the landing zone (500) that needs to be implemented in the IT infrastructure (600) and are derived from a preconfigured landing zone (500a) and the questions (q1, q2) need to be answered by a user of the IT infrastructure (600);
a Response Validation Interface (RVI) (240) associated with a second computing device (C2), the RVI (240) is connected to the URI (220) for gathering details of the answers (a1, a2) and the questions (q1, q2) thereto, and the RVI (240) is accessible to an approval authority (700) to approve or reject an implementation of the preconfigured landing zone (500a) in the IT infrastructure (600) based on the answers (a1, a2) by the user to the questions (q1, q2); and
a deployment orchestrator (260) associated the first computing device (C1), the second computing device (C2), wherein the deployment orchestrator (260) is connected with the URI (220), the RVI (240) and the IT infrastructure (600), wherein the deployment orchestrator (260) deploys an approved landing zone (500b) in the IT infrastructure (600).

2. The system (200) as claimed in claim 1, wherein the URI (220) includes an updating portal (224), when the approval authority (700) rejects the implementation of the landing zone (500), the user updates the answers to the questions (q1, q2) in the updating portal (224).

3. The system (200) as claimed in claim 1, wherein:
the first module (230a) includes questions (q1, q2) related to a foundation stage (S1) of the landing zone implementation;
the second module (230b) includes questions (q1, q2) related to an identity stage (S2) of the landing zone implementation;
the third module (230c) includes questions (q1, q2) related to an access management stage (S3) of the landing zone implementation;
the fourth module (230d) includes questions (q1, q2) related to a network configuration stage (S4) of the landing zone implementation; and
the fifth module (230e) includes questions (q1, q2) related to Security stage (S5) of the landing zone implementation.

4. The system (200a) as claimed in claim 3, wherein configurations related to the foundation stage (S1) are deployed by a deployment orchestrator (260a) firstly for the implementation of the landing zone (500).

5. The system (200b) as claimed in claim 1, wherein the Response Validation Interface (RVI) (240) includes a questions modifier (246), when the approval authority (700) rejects the implementation of the landing zone (500), if the configuration of the landing zone (500) is modified, the questions modifier (246) modifies the questions (q3, q4) according to a modified landing zone (500c) that will be implemented upon approval from the approval authority (700).

6. The system (200) as claimed in claim 1, wherein the IT infrastructure (600) is an on-prem IT infrastructure (600a) or a cloud infrastructure (600b) or a hybrid infrastructure (600c) or a SaaS infrastructure (600d).

7. The system (200d) as claimed in claim 1, wherein the system (200d) includes a console (250) with the User Response Interface (URI) (220), the Response Validation Interface (RVI) (240) and the deployment orchestrator (260), the console (250) is configured in the computing device (C1).

8. A cloud platform (400) for implementing a Landing Zone (500) in an IT infrastructure (600) for deploying and managing cloud computing operations, the cloud platform (400) is configured in a processor with a memory of the IT infrastructure (600), the cloud platform (400) comprising:
a User Response Interface (URI) (420) with five modules (230a, 230b, 230c, 230d, 230e),each module (230a/ 230b/ 230c/ 230d/ 230e) is having one or more questions (q1, q2), the questions (q1, q2) are related to the landing zone (500) that needs to be implemented in the IT infrastructure (600) and are derived from a preconfigured landing zone (500a) and the questions (q1, q2) need to be answered by a user of the IT infrastructure (600);
a Response Validation Interface (RVI) (440) connected to the URI (420) for gathering details of the answers (a1, a2) and the questions (q1, q2) thereto, and the RVI (440) is accessible to an approval authority (700) to approve or reject an implementation of the preconfigured landing zone (500a) in the IT infrastructure (600) based on the answers (a1, a2) by the user to the questions (q1, q2); and
a deployment orchestrator (460) connected with the URI (420), the RVI (440) and the IT infrastructure (600), wherein the deployment orchestrator (460) deploys an approved landing zone (500b) in the IT infrastructure (600).

9. The cloud platform (400a) as claimed in claim 8, wherein the the User Response Interface (URI) (420a), the Response Validation Interface (RVI) (440a) and the deployment orchestrator (460a) are SaaS applications.

10. The system (200) as claimed in claim 1, wherein the User Response Interface (URI) (220) comprises an interface trigger (225) for activating the functioning of the URI (220), the interface trigger (225) comprises a clickable button on the display (521d) of the first computing device (C1) or a voice command interface for initiating the landing zone (500) implementation process.

11. The system (200) as claimed in claim 1, wherein each module (230a/230b/230c/230d/230e) comprises a library associated with the memory (m1), the library stores the questions (q1, q2) in a structured format, the library comprises a relational database or a NoSQL database, the library organizes the questions (q1, q2) according to the five modules (230a, 230b, 230c, 230d, 230e), and the library supports real-time updates to the questions (q1, q2) through administrative access.

12. The system (200) as claimed in claim 11, wherein the system (200) comprises a machine learning module communicatively connected to the library, the machine learning module analyzes historical answers (a1, a2) and updates the questions (q1, q2) based on based on recurring configuration patterns identified in historical user responses, enabling dynamic refinement of subsequent questions, the machine learning module comprises a natural language processing engine, and the machine learning module communicates with the library to modify the questions (q1, q2) dynamically based on user interaction patterns and deployment outcomes.

13. The system (200) as claimed in claim 1, wherein the memory (523) stores the answers (a1, a2) in a structured data format, the memory (523) organizes the answers (a1, a2) according to the corresponding questions (q1, q2) and the modules (230a, 230b, 230c, 230d, 230e), each answer (a1/a2) is tagged with metadata including a timestamp, a user identifier, and a module identifier, the memory (523) supports concurrent read and write operations, and the memory (523) maintains version history of the answers (a1, a2) to enable rollback to previous configurations.

14. The system (200) as claimed in claim 1, wherein the Response Validation Interface (RVI) (240) implements authentication mechanisms to control access by the approval authority (700), the authentication comprises username and password verification or multi-factor authentication requiring a time-based one-time password or biometric authentication, the RVI (240) maintains an access log recording each login attempt by the approval authority (700), and the RVI (240) enforces session timeout policies to terminate inactive sessions.

15. The system (200) as claimed in claim 1, wherein the deployment orchestrator (260) comprises a set of execution modules that automate the deployment of the approved landing zone (500b) in the IT infrastructure (600), the deployment orchestrator (260) utilizes infrastructure-as-code tools for provisioning infrastructure resources, the deployment orchestrator (260) reads the answers (a1, a2) from the memory (523) and converts the answers (a1, a2) into deployment scripts, the deployment scripts define the configuration parameters for the landing zone (500), and the deployment orchestrator (260) executes the deployment scripts sequentially according to stage dependencies.

16. The system (200) as claimed in claim 15, wherein the deployment orchestrator (260) comprises a deployment trigger (262) for initiating the functioning of the deployment orchestrator (260), the deployment trigger (262) comprises an API call from the Response Validation Interface (RVI) (240) or a manual button click by an administrator on a deployment dashboard, the deployment orchestrator (260) verifies that the approved landing zone (500b) has valid approval status before commencing deployment, and the deployment orchestrator (260) logs each deployment step in a deployment log comprising timestamps, status codes, and error messages.

17. The system (200) as claimed in claim 1, wherein the User Response Interface (URI) (220) comprises an updating portal (224), the updating portal (224) retrieves rejection comments from the Response Validation Interface (RVI) (240) and displays the rejection comments alongside the relevant questions (q1, q2), the updating portal (224) highlights the questions (q1, q2) requiring modification, the user (U1) enters the updated answers (a3, a4) through input fields in the updating portal (224), the updating portal (224) validates the format and content of the updated answers (a3, a4), the updating portal (224) stores the updated answers (a3, a4) in the memory (523) with a version number indicating the revision, and the updating portal (224) notifies the Response Validation Interface (RVI) (240) that updated answers (a3, a4) are available for review.

18. The system (200d) as claimed in claim 7, wherein the console (250) is accessed through a web-based application running in a web browser on the computing device (C1), the console (250) presents navigation controls allowing the user (U1) and the approval authority (700) to switch between the URI (220), the RVI (240), and the deployment orchestrator (260), the console (250) implements role-based access control restricting access to specific components based on user roles, the console (250) displays real-time status updates for ongoing deployments, and the console (250) communicates with the memory (m1) and the memory (533) to retrieve and display data.

19. The cloud platform (400) as claimed in claim 8, wherein the cloud platform (400) is deployed on cloud infrastructure (600b) comprising virtualized computing resources, the cloud platform (400) utilizes cloud-native services for implementing the User Response Interface (URI) (420), the Response Validation Interface (RVI) (440), and the deployment orchestrator (460), the URI (420) is deployed as a containerized application for managing container instances, the RVI (440) is implemented as a microservice accessible through RESTful APIs, the deployment orchestrator (460) integrates with cloud service provider APIs to provision resources in the cloud infrastructure (600b), and the cloud platform (400) implements auto-scaling capabilities adjusting computing resources based on workload demand.

20. A method (800) for implementing a Landing Zone (500) in an IT infrastructure (600) for deploying and managing computing operations, the method (800) comprising:
Configuring (810) a User Response Interface (URI) (220/420), a Response Validation Interface (RVI) (240/440) and a deployment orchestrator (260/460) in a computing device (C1) of the IT infrastructure (600) and the User Response Interface (URI) (220/420) comprises five modules (230a, 230b, 230c, 230d, 230e), each module (230a/230b/230c/230d/230e) is having one or more questions (q1, q2), the questions (q1, q2) are related to the landing zone (500) that needs to be implemented in the IT infrastructure (600) and are derived from a preconfigured landing zone (500a) and;
answering (820) to the questions (q1, q2) by a user, the RVI (240/440) is connected to the URI (220/420) for gathering details of the answers (a1, a2) and the questions (q1, q2) thereto, and the RVI (240/440) is accessible to an approval authority (700);
approving (830) or rejecting an implementation of the preconfigured landing zone (500a) in the IT infrastructure (600) based on answers (a1, a2) by the user to the questions (q1, q2) by approval authority (700); and
deployment (840) of an approved landing zone (500b) in the IT infrastructure (600) by the deployment orchestrator (260/460).
